(19) United States
(12) Patent Application Publication
(10) Pub. No.: US 2025/0378416 A1
(43) Pub. Date: Dec. 11, 2025

(54) SYSTEMS AND METHODS FOR DETERMINING SHUTTLE LOADING POSITIONS FOR A MULTI-LOAD SHUTTLE

(71) Applicant: INTELLIGRATED HEADQUARTERS, LLC, Mason, OH (US)

(72) Inventors: Adin Richardson, Cincinnati, OH (US); Thomas Keller, West Chester, OH (US)

(21) Appl. No.: 18/735,914

(22) Filed: Jun. 6, 2024

(51) Int. Cl. G06Q 10/087

(52) U.S. Cl. CPC G06Q 10/087

(57) ABSTRACT

Embodiments of the present disclosure provide systems and methods for determining shuttle loading positions for a multi-load shuttle. In one embodiment, a method includes receiving, by one or more processors, an indication of a first load for retrieval by a shuttle that is configurable to simultaneously transport a plurality of loads and an indication of a first retrieval location for the first load; receiving, by the one or more processors, an indication of a second load for retrieval by the shuttle and an indication of a second retrieval location for the second load; determining, by the one or more processors, a first loading position on the shuttle for placing the first load based on the first retrieval location and the second retrieval location; and causing, by the one or more processors, the shuttle to place the first load in the first loading position based on determining the first loading position.

### TECHNICAL FIELD

Embodiments of the present disclosure generally relate to the field of order fulfilment, and specifically to systems and methods for determining shuttle loading positions for a multi-load shuttle.

### BACKGROUND

Some fulfilment systems utilize shuttles to retrieve items from storage and transport the items to a drop location. For example, a shuttle may receive a request indicating an item for retrieval, travel to a location where the item is stored, pick the item from the storage location, place the item on the shuttle, and transport the item to a drop location. In some examples, a shuttle may be capable of transporting multiple items simultaneously. However, existing control systems may not be capable of coordinating the retrieval of such items in an efficient manner, which may present challenges, such as increased cycle time and increased energy consumption associated with the performance of duplicative or unnecessary operations. For example, in some conventional systems, a shuttle may load a first item of an order onto the shuttle in a manner that blocks a second item from being loaded onto the shuttle. In such examples, the shuttle may reposition the first item prior to loading the second item, which may increase cycle time and energy consumption. Additionally, such conventional systems may not consider drop sequencing when retrieving items, which may necessitate the reshuffling of items subsequent to item drop off. For example, some conventional shuttle systems may be configured to retrieve items in an order that item retrieval requests are received, which may present challenges in a scenario where order sequencing does not match a preferred drop sequence. Accordingly, such conventional systems may necessitate manual or automated reshuffling of items subsequent to item retrieval, which may increase costs and complexity associated with such systems.

### BRIEF SUMMARY

In accordance with a first aspect of the disclosure, a method is provided. In some embodiments, the method is executable by one or more computing devices embodied in hardware, software, firmware, and/or any combination thereof as described herein. In some examples, the method may include receiving, by one or more processors, (i) an indication of a first load for retrieval by a shuttle that is configurable to simultaneously transport a plurality of loads and (ii) an indication of a first retrieval location for the first load; receiving, by the one or more processors, (a) an indication of a second load for retrieval by the shuttle and (b) an indication of a second retrieval location for the second load; determining, by the one or more processors, a first loading position on the shuttle for placing the first load based at least in part on the first retrieval location and the second retrieval location; and causing, by the one or more processors, the shuttle to place the first load in the first loading position based at least in part on determining the first loading position.

In some examples, the one or more processors may determine that the first retrieval location and the second retrieval location are on a same side of the shuttle, wherein the first loading position is based on the determining that the first retrieval location and the second retrieval location are on a same side of the shuttle. In some examples, the one or more processors may cause the shuttle to place the second load in a second loading position without repositioning the first load.

In some examples, the second loading position is closer to an outer edge of the shuttle than the first loading position. In some examples, the first loading position is based on a load delivery sequence. In some examples, the one or more processors may receive an indication of the load delivery sequence. In some examples, the shuttle may include the one or more processors.

In accordance with a second aspect of the disclosure, an apparatus is provided. In one example embodiment of the apparatus, the apparatus includes one or more processors and a memory storing instructions that, when executed by the one or more processors, cause the apparatus to perform any one or more of the methods described herein. A second example apparatus includes means for performing each step of any one of the methods described herein.

In accordance with a third aspect of the disclosure, a system is provided. In one example embodiment of the system, the system includes an aisle controller and one or more processors in communication with the aisle controller, wherein the one or more processors are configured to perform any one or more of the methods described herein. In one example embodiment of the system, an example system includes at least one non-transitory computer-readable storage medium having computer program code stored thereon that, in combination with one or more processors, is configured for performing any one of the example methods described herein.

### BRIEF DESCRIPTION OF THE DRAWINGS

FIG. 1 illustrates a system for determining shuttle loading positions for a multi-load shuttle in accordance with one or more embodiments of the present disclosure.

FIG. 2 illustrates a block diagram of a computing device for determining shuttle loading positions for a multi-load shuttle in accordance with one or more embodiments of the present disclosure.

FIG. 3 is a system diagram showing example devices and components for determining shuttle loading positions for a multi-load shuttle in accordance with one or more embodiments of the present disclosure.

FIG. 4 is a dataflow diagram showing example data structures and modules for determining shuttle loading positions for a multi-load shuttle in accordance with one or more embodiments of the present disclosure.

FIG. 5 is an operational example of a system architecture that supports determining shuttle loading positions for a multi-load shuttle in accordance with one or more embodiments of the present disclosure.

FIG. 6 is an operational example of shuttle loading configurations that support determining shuttle loading positions for a multi-load shuttle in accordance with one or more embodiments of the present disclosure.

FIG. 7 is an operational example of a process that supports determining shuttle loading positions for a multi-load shuttle in accordance with one or more embodiments of the present disclosure

FIG. 8 is an operational example of a process that supports determining shuttle loading positions for a multi-load shuttle in accordance with one or more embodiments of the present disclosure.

FIG. 9 is an operational example of a process that supports determining shuttle loading positions for a multi-load shuttle in accordance with one or more embodiments of the present disclosure.

FIG. 10 is an operational example of a system architecture that supports determining shuttle loading positions for a multi-load shuttle in accordance with one or more embodiments of the present disclosure.

FIG. 11 is an operational example of a system architecture that supports determining shuttle loading positions for a multi-load shuttle in accordance with one or more embodiments of the present disclosure.

FIG. 12 is an operational example of a system architecture that supports determining shuttle loading positions for a multi-load shuttle in accordance with one or more embodiments of the present disclosure.

FIG. 13 is an operational example of a process that supports determining shuttle loading positions for a multi-load shuttle in accordance with one or more embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### OVERVIEW

Some fulfilment systems utilize shuttles to retrieve items from storage and transport the items to a drop location. For example, a shuttle may receive a request indicating an item for retrieval, travel to a location where the item is stored, pick the item from the storage location, place the item on the shuttle, and transport the item to a drop location. In some examples, a shuttle may be capable of transporting multiple items simultaneously. However, existing control systems may not be capable of coordinating the retrieval of such items in an efficient manner, which may present challenges, such as increased cycle time and increased energy consumption associated with the performance of duplicative or unnecessary operations. For example, in some conventional systems, a shuttle may load a first item of an order onto the shuttle in a manner that blocks a second item from being loaded onto the shuttle. In such examples, the shuttle may reposition the first item prior to loading the second item, which may increase cycle time and energy consumption. Additionally, such conventional systems may not consider drop sequencing when retrieving items, which may necessitate the reshuffling of items subsequent to item drop off. For example, some conventional shuttle systems may be configured to retrieve items in an order that item retrieval requests are received, which may present challenges in a scenario where order sequencing does not match a preferred drop sequence. Accordingly, such conventional systems may necessitate manual or automated reshuffling of items subsequent to item retrieval, which may increase costs and complexity associated with such systems.

In accordance with one or more examples described herein, improved systems and methods for determining shuttle loading positions for a multi-load shuttle are provided. For example, one or more processors (e.g., of a shuttle) may determine a loading position for a first load that enables the shuttle to avoid repositioning the load when retrieving one or more second loads. For example, the one or more processors may determine to place a first load in a first loading position (e.g., an interior loading position) and a second load in a second loading position (e.g., an exterior loading position). Placing the first load in the first loading position may enable the shuttle to place the second load in the second loading position without repositioning the first load (e.g., without moving the first load from the second loading position to the first loading position), which may conserve energy consumption and reduce cycle time. In some examples, the one or more processors may determine the one or more loading positions based on one or more retrieval locations for one or more loads. For example, the one or more processors may determine that two or more loads are to be loaded onto the shuttle from a same side. In response to determine that the two or more loads are to be loaded onto the shuttle from the same side, the one or more processors may determine loading positions that optimize placement efficiency. For example, such techniques for determining loading positions may enable multiple loads to be placed on a shuttle without repositioning loads during a load retrieval process (e.g., while loads for a single order are being retrieved).

In some examples, the one or more processors may determine one or more loading positions for one or more loads based on a drop sequence for the one or more loads. For example, the one or more processors may receive an indication of a drop sequence, which may indicate a preferred sequence or ordering for one or more items to be dropped off by a shuttle. The one or more processors may then determine the one or more loading positions based on the drop sequence. Accordingly, the shuttle may then retrieve and deliver the one or more loads in the preferred drop sequence without repositioning the one or more loads or necessitating that the one or more loads be subsequently repositioned. In some examples, the one or more processors may determine the one or more loading positions based on the one or more retrieval locations for one or more loads and based on the drop sequence. Accordingly, such techniques may provide multiple improvements when compared to conventional techniques, such as reduced cycle time, reduced operational complexity, reduced operational costs, and reduced energy consumption.

### DEFINITIONS

In some embodiments, the term “shuttle” refers to a device or component that transports one or more loads (e.g., items, objects, payloads, products) to one or more locations within a system, such as an order fulfilment system. A shuttle may be propelled by one or more motion systems, such as one or more motors, one or more drive systems (e.g., belt drive systems), and/or the like. As described herein, a shuttle may be an example of a subcomponent of an automated storage and retrieval system (ASRS). In some examples, a shuttle may be equipped with one or more control systems, such as one or more computing devices (e.g., including one or more processors), which may be configured to control the movement and/or operations of the shuttle by communicating one or more control signals to the one or more motion systems and/or load selection systems (e.g., arms and/or fingers for retrieving loads) of the shuttle and/or one or more systems configured to steer, orient, or otherwise position the shuttle.

In some examples, a shuttle may communicate with one or more other devices or components of an order fulfillment system via a wireless and/or wired network. For example, a computing device of a shuttle may include communication circuitry, which may enable the shuttle to wirelessly communicate with one or more other devices. In some examples, a shuttle may be in communication with one or more external computing devices, such as an aisle controller and/or a computing device that hosts an order management system. In such examples, the shuttle may receive one or more messages from the one or more external computing devices. For example, the shuttle may receive one or more messages including one or more indications from an aisle controller. In some examples, the one or more messages may include one or more orders. In such examples, an order may indicate load retrieval information, such as any combination of one or more loads for retrieval by the shuttle, one or more retrieval locations for the one or more loads (e.g., one or more pickup locations), one or more load delivery sequences, one or more drop locations for the one or more loads, one or more measurements for the one or more loads (e.g., load lengths, load widths, load heights, load volumes, load weights), one or more load identifiers for the one or more loads (e.g., load barcodes, alphabetic and/or numeric identifiers), one or more side identifiers for the one or more loads (e.g., indicative of which side of the shuttle the one or more loads are stored on), and/or the like.

In some examples, the shuttle may receive the load retrieval information and determine one or more loading positions for the one or more loads based on the load retrieval information. For example, the shuttle may determine to place a first load retrieved from a first side of the shuttle at an interior loading position (e.g., a first loading position) based on load retrieval information that indicates a second load is to be retrieved from the first side (e.g., subsequent to the retrieval of the first load). Accordingly, placing the first load at the interior loading position may enable the second load to be placed at the exterior position without repositioning (e.g., reshuffling) the first load, which may conserve power and improve cycle time.

As described herein, a shuttle may be an example of a multi-load shuttle, which may be capable of transporting a plurality of loads simultaneously. In such examples, a shuttle may receive an order requesting the retrieval of multiple loads, the shuttle may depart from a starting location (e.g., a home location, a drop location), the shuttle may retrieve the multiple loads without iteratively returning to the drop location between loads, and the shuttle may deliver the multiple loads to the drop location together (e.g., at one time). By transporting the multiple loads simultaneously, power consumption and cycle time may be reduced.

In some examples, an algorithm (e.g., a preplanning algorithm) may be executed (e.g., by one or more computing devices, by one or more computing devices of a shuttle) to determine loading positions for loads retrieved by a shuttle. As described herein, the algorithm may enable the optimization of load retrieval and placement operations such that reshuffling of loads (e.g., on the shuttle, after the shuttle is unloaded) is minimized for a given order. For example, a computing device (e.g., of the shuttle) may determine that one or more loads are to be retrieved or otherwise loaded onto the shuttle from the same side. Accordingly, the computing device may determine that the first load should be placed at an interior loading position, which may enable the shuttle to efficiently load a second load to an exterior loading position (e.g., without having to move the first load from the exterior loading position to the interior loading position).

In some examples, a computing device (e.g., of the shuttle) may additionally, or alternatively determine (e.g., using the algorithm) one or more loading positions for one or more loads retrieved by the shuttle based on a drop sequence for the one or more loads. For example, the computing device may initially determine a shuttle loading sequence for loading the shuttle such that loads are positioned on the shuttle in accordance with the drop sequence. Such operations may enable the shuttle to drop the one or more loads sequentially in the drop sequence without reshuffling the loads. Once the shuttle has determined the loading sequence based on the drop sequence, the shuttle may then place the one or more loads in the one or more loading positions that are determined based on the drop sequence and/or the one or more load retrieval locations for the one or more loads.

Some examples described herein refer to a computing devices of the shuttle performing operations, making determinations, and/or executing algorithms. However, any other computing device may perform any one or more of the operations described herein. For example, an aisle controller may execute the preplanning algorithm as described herein and communicate one or more control signals to the shuttle to cause the shuttle to perform one or more operations. As another illustrative example, the aisle controller may make one or more first determinations and a computing device of the shuttle may make one or more second determinations. For example, the aisle controller may determine a loading sequence based on a drop sequence and communication the loading sequence to the shuttle. The shuttle may then determine one or more loading positions for the one or more loads based on the drop sequence received from the aisle controller.

In some embodiments, the term “loading position” refers to a position or location on a shuttle. For example, a shuttle may include a flat surface or platform where one or more containers or pallets may be placed. As described herein, the locations of the containers or pallets on the shuttle may be referred to as loading positions. In some examples, a shuttle may have multiple loading positions, which may be preconfigured or otherwise fixed. In some other examples, one or more loading positions of a shuttle may be configurable or otherwise dynamically determined based on one or more factors, parameters, and/or conditions. For example, a computing device of a shuttle may determine one or more loading positions based on one or more size parameters for one or more loads, such as load length.

In some examples, one or more computing devices may determine one or more loading positions based on one or more load retrieval locations for one or more loads and/or based on the retrieval sequence for the one or more loads. For example, the one or more computing devices may determine that two loads for retrieval (e.g., as part of a single order) are stored on a same side of a shuttle (e.g., in one or more shelving units located on a left side of the shuttle). A first load of the two loads may be queued for retrieval prior to retrieval of a second load of the two loads. Accordingly, the one or more computing devices may determine a first loading position for a first load of the two loads and a second loading position for a second load of the two loads. The first loading position may be an interior loading position and the second loading position may be an exterior loading position. The determined loading positions may enable the second load to be loaded onto the shuttle without reshuffling or otherwise moving the first load.

In some embodiments, the term “retrieval location” refers to a location or position of a load within a storage area or device. For example, a retrieval location may be a location of a container within a container storage shelving unit. In some examples, an order may include one or more indications of one or more retrieval locations for one or more loads. As described herein, one or more computing devices may determine one or more loading positions based on one or more retrieval locations for one or more loads. For example, a computing device may determine to place a first load in a first loading position (e.g., an interior loading position) if the first load and a second load are located on a same side of a shuttle.

In some embodiments, the term “side” refers to a position or location relative to a central point or a component of an order fulfilment system. For example, ASRS may include a shuttle that travels in two directions along a track. The track may be flanked by shelving units on either side of the shuttle. For example, a first shelving unit may be located on a left side of the shuttle (e.g., side 1) and a second shelving unit may be located on a right side of the shuttle (e.g., side 2).

In some embodiments, the term “outer edge” refers to a geometrical region of a shuttle. For example, an outer edge of a shuttle may be an edge or extent of a shuttle that is parallel to the direction of travel of the shuttle. In some examples, a load that is placed onto the shuttle may cross over a plane that is parallel with the outer edge of the shuttle. In some examples, a shuttle may have multiple outer edges. For example, a first outer edge of the shuttle may be located on a first side of the shuttle (e.g., side 1, the left side of the shuttle) and a second outer edge of the shuttle may be located on a second side of the shuttle (e.g., side 2, the right side of the shuttle).

In some examples, a loading position may be described with reference to one or more outer edges of a shuttle. For example, a first loading position (e.g., a first interior loading position) may be further from a first outer edge (e.g., a left outer edge) of a shuttle than a second loading position (e.g., a first exterior loading position). Additionally, or alternatively, a third loading position (e.g., a second interior loading position) may be further from a second outer edge (e.g., a right outer edge) of a shuttle than a further loading position (e.g., a second exterior loading position).

In some embodiments, the term “repositioning” refers to moving, shuffling, or otherwise reorganizing one or more loads on a shuttle or in any other region of an order fulfilment system. For example, a shuttle may perform one or more operations to move a first load from a first loading position to a second loading position. As another illustrative example, a shuttle may drop a plurality of loads at a drop location. The plurality of loads may be transported to a sorting area and one or more individuals may reposition the plurality of loads. As described herein, some conventional load retrieval techniques may include repositioning a load from a first loading position to a second loading position (e.g., to make room for a second load to be loaded onto a shuttle). For example, a conventional load retrieval technique may include placing a first load in a second loading position of a shuttle (e.g., an exterior loading position) and then repositioning or otherwise moving the first load from the second loading position to a first loading position (e.g., an interior loading position) to make room for a second load to be loaded into the second loading position. However, such repositioning operations may be slower and may consume more energy resources than the techniques of the present disclosure.

In some embodiments, the term “load delivery sequence” refers to a sequence or ordering for unloading, outputting, or delivery two or more loads. For example, a shuttle may delivery two or more loads to one or more subsystems or subcomponents of an order fulfilment system in a specific load delivery sequence. In some examples, a load delivery sequence may be specified or otherwise indicated by an order. In some examples, one or more computing devices may determine one or more loading positions for one or more loads based on a load delivery sequence.

In some embodiments, the term “load” refers to an object or item that is conveyed by a shuttle in an order fulfilment system. A load may include a container or pallet, either of which may include one or more items. As described herein, a load may be stored at one or more storage locations (e.g., retrieval locations). A shuttle may then remove a load from a retrieval location and place the load at one or more loading positions of the shuttle. The shuttle may then convey the load to a delivery location (e.g., a drop location). In some examples, a load may be identified using one or more load identifiers, such as a barcode, an alphabetic code, and/or a numeric code.

In some embodiments, the term “aisle controller” refers to a computing device that is configurable to perform any one or more of the operations described herein. For example, an aisle controller may be in communication with a computing device of a shuttle and/or an order management system, which may itself include one or more computing devices. The aisle controller may receive information from the order management system, such as one or more orders, and communicate the information to the computing device of the shuttle.

In some embodiments, the term “order management system” refers to a system for organizing, managing, communicating, and/or tracking information associated with one or more loads in an order fulfilment system. In some examples, an order management system may include software, hardware, or any combination thereof that enables information to be organized, managed, communicated, and/or tracked. For example, an order management system may include one or more computing devices that communicate one or more orders to one or more aisle controllers. An order management system may perform any one or more of the operations described herein. In some examples, an order management system may be an example of a warehouse execution system (WES).

In some embodiments, the term “order” refers to a message or communication that indicates one or more loads to be retrieved by a shuttle. For example, an order may be indicative of a request for a shuttle to retrieve one or more loads from one or more retrieval locations. In some examples, an order may be a message that includes various types of information. For example, an order may include one or more indications of one or more retrieval locations (e.g., pick locations), one or more indications of one or more drop locations, one or more indications of one or more load dimensions (e.g., load lengths), one or more indications of one or more load identifiers, and/or one or more indications of one or more load sides (e.g., indications of which side of a shuttle a load is stored on).

### EXAMPLE SYSTEMS AND PROCESSES OF THE DISCLOSURE

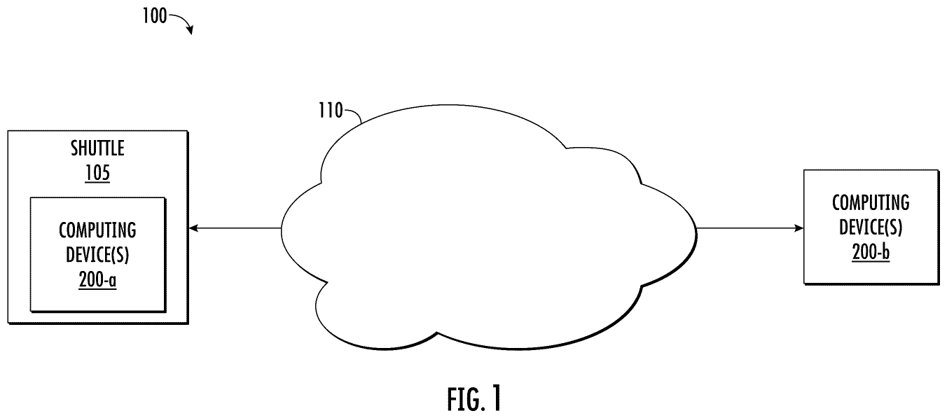

FIG. 1 illustrates a system for determining shuttle loading positions for a multi-load shuttle in accordance with one or more embodiments of the present disclosure. Specifically, FIG. 1 depicts an example system 100 within which embodiments of the present disclosure may operate to perform the techniques described herein. For example, any one or more of the devices and/or systems described with reference to FIG. 1 may perform any one or more of the techniques described herein. As depicted, the system 100 includes one or more computing devices 200-a, which may be computing devices 200 of a shuttle 105. The system 100 may also include one or more computing devices 200-b, which may be in communication with the one or more computing devices 200-a. In some examples, the one or more computing devices 200-a may communicate with the one or more computing devices 200-b over one or more communication networks, such as the communication network 110.

In some embodiments, the one or more computing devices 200-a may include any number of computing devices 200, entities, and/or systems embodied in hardware, software, firmware, and/or a combination thereof that control, operate, and/or are onboard a shuttle 105. In some examples, the one or more computing devices 200-a may control or otherwise communicate with one or more physical components of the shuttle 105, including and without limitation one or more displays, one or more drive systems, one or more motors, one or more antennas, one or more sensors, one or more load selection devices, and/or the like. In some embodiments, the shuttle 105 may include one or more sensors (e.g., one or more cameras, one or more sensors of a camera) that gather, collect, and/or otherwise aggregate sensor data associated with the shuttle 105 and/or an environment associated therewith.

Additionally, or alternatively, in some embodiments, the one or more computing devices 200-a may include one or more computing devices and/or systems that generate one or more user interfaces capable of being rendered to one or more displays of the one or more computing devices 200-a. Additionally, or alternatively, in some embodiments, the one or more computing devices 200-a include one or more computing devices and/or systems that generate and/or maintain data embodying and/or utilized to recreate a virtual environment including virtual aspects corresponding to and/or associated with a real-world environment. It will be appreciated that the shuttle 105 may include any number of physical components that enable the shuttle 105 to operate in a particular manner of travel.

In some embodiments, the one or more computing devices 200-a include one or more personal computers, one or more end-user terminals, one or more monitors, and/or one or more displays. Additionally, or alternatively, in some embodiments, the one or more computing devices 200-a include one or more data repositories embodied in hardware, software, firmware, and/or any combination thereof to support functionality provided by the one or more computing devices 200-a. In some embodiments, the one or more computing devices 200-a may include one or more specially configured integrated systems that process data received by and/or controlled by one or more computing devices 200-b.

In some examples, the one or more computing devices 200-a may receive data from the one or more computing devices 200-b that provides additional context with respect to the environment in which the shuttle 105 is operating. For example, in some embodiments, the one or more computing devices 200-a may communicate with the one or more computing devices 200-b to determine a position of one or more other shuttles or objects, such as loads, shelving units, and/or the like. Additionally, or alternatively, in some embodiments, the one or more computing devices 200-a may communicate with the one or more computing devices 200-b to receive sensor data of a particular data type that is not capturable directly by the one or more computing devices 200-a. For example, in some embodiments, the shuttle 105 may not include a particular sensor for capturing a particular type of data, and instead may receive such data of the particular data type from the one or more computing devices 200-b.

In some embodiments, the one or more computing devices 200-b may be examples of systems and/or devices capable of communicating or otherwise sharing data with the one or more shuttles 105. In some examples, the one or more computing devices 200-b may generate data. That is, data may originate from the one or more computing devices 200-b. Additionally, or alternatively, the one or more computing devices 200-b may receive data that originates from one or more other sources and communicate or otherwise relay the data to one or more devices. The one or more computing devices 200-b may include one or more data storage systems, such as volatile or non-volatile memory devices.

The one or more computing devices 200-b may include one or more computing devices and/or systems that store and/or generate data. In some examples, the data may represent one or more aspects of a real-world environment, object therein, and/or shuttle 105 therein. In some embodiments, the one or more computing devices 200-b include one or more application servers, one or more end user terminals, one or more personal computers, one or more mobile devices, one or more user devices, and/or the like. Additionally, or alternatively, in some embodiments, the one or more computing devices 200-b include one or more database server specially configured to store data pushed from one or more other computing devices and/or systems (e.g., the one or more computing devices 200-a) and/or retrieve data in response to one or more queries from one or more other computing devices and/or systems. In some embodiments, the one or more computing devices 200-b include one or more remote and/or cloud computing devices accessible to the shuttle 105 over a communications network, such as the communications network 110.

In some embodiments the communications network 110 enables communication between the various computing devices and/or systems utilizing one or more combinations of wireless and/or wired data transmissions and protocols. In this regard, the communications network 110 may embody any of a myriad of network configurations. In some embodiments, the communications network 110 embodies a public network (e.g., the internet) in whole or in part. In some embodiments, the communications network 110 embodies a private network (e.g., an internal network between particular computing devices) in whole or in part. Additionally, or alternatively, in some embodiments the communications network 110 embodies a direct or private connection facilitated over satellite and/or radio systems. In some other embodiments, the communications network 110 embodies a hybrid network (e.g., a network enabling internal communications between connected computing devices and external communications with other computing devices).

The communications network 110 may include one or more base stations, one or more relays, one or more routers, one or more switches, one or more cell towers, one or more communications cables, one or more satellites, one or more radio antennas, and/or one or more related control systems and/or associated routing stations. In some embodiments, the communications network 110 includes one or more user entity-controlled computing devices and/or other enterprise devices (e.g., an end-user or enterprise router, modem, switch, and/or other network access point) and/or one or more external utility devices (e.g., one or more internet service provider communication towers, one or more cell towers, and/or one or more other devices).

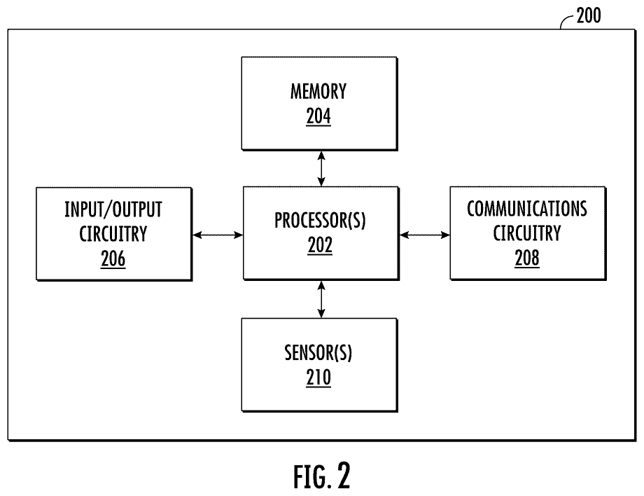

FIG. 2 illustrates a block diagram of a computing device for determining shuttle loading positions for a multi-load shuttle in accordance with one or more embodiments of the present disclosure. Specifically, FIG. 2 depicts a computing device 200. As depicted, the computing device 200 includes one or more processors 202, one or more memories 204, input/output circuitry 206, communications circuitry 208, and/or one or more sensors 210, any of which may perform any one or more operations as described herein.

In some embodiments, the computing device 200 is configured, using one or more of the sets of circuitry embodying the processor 202, the memory 204, the input/output circuitry 206, the communications circuitry 208, and/or the one or more sensors 210 to execute any one or more of the operations described herein. Although components are described with respect to functional limitations, the particular implementations may include the user of the particular computing hardware, who may provide inputs to and/or receive outputs from the computing device 200 via the input/output circuitry 206. It should also be understood that in some embodiments certain components described herein include similar or common hardware. For example, two sets of circuitry may both leverage use of the same processor 202, network interface, storage medium, and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Additionally, or alternatively, in some embodiments, other elements of the computing device 200 may provide or supplement the functionality of another particular set of circuitry. For example, the processor 202 in some embodiments provides processing functionality to any of the other sets of circuitry, the memory 204 provides storage functionality to any of other the sets of circuitry, the communications circuitry 208 provides network interface functionality to any of the other sets of circuitry, and/or the like.

In some embodiments, the processor 202 (and/or co-processor or any other processing circuitry assisting or otherwise associated with the processor) is/are in communication with the memory 204 via a bus for passing information among components of the computing device 200. In some embodiments, for example, the memory 204 is non-transitory and includes, for example, one or more volatile and/or non-volatile memories. In other words, for example, the memory 204 may include or embody an electronic storage device (e.g., a computer readable storage medium). In some embodiments, the memory 204 is configured to store information, data, content, applications, instructions, or the like, for enabling the computing device 200 to carry out various functions in accordance with example embodiments of the present disclosure.

In various embodiments, the processor 202 is embodied in a number of different ways. For example, in some example embodiments, the processor 202 includes one or more processing devices configured to operate independently. Additionally, or alternatively, in some embodiments, the processor 202 includes a processor configured in tandem via a bus to enable independent execution of instructions, pipelining, and/or multithreading. The use of the terms “processor” and “processing circuitry” should be understood to include a single core processor, a multi-core processor, multiple processors internal to the computing device 200, and/or one or more remote or cloud-based processors external to the computing device 200.

In an example embodiment, the processor 202 is configured to execute instructions stored in the memory 204 or otherwise accessible to the processor 202. Additionally, or alternatively, the processor 202 may be configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Additionally, or alternatively, as another example, when the processor 202 is embodied as an executor of software instructions, the instructions specifically configure the processor 202 to perform the algorithms embodied in the specific operations described herein when such instructions are executed.

In some embodiments, computing device 200 includes input/output circuitry 206 and/or communications circuitry 208 that provides output to a user and/or receives input from a user. In some embodiments, the input/output circuitry 206 and/or the communications circuitry 208 is/are in communication with the processor 202 to provide such functionality. The input/output circuitry 206 may comprise one or more user interfaces and in some embodiments includes one or more displays that comprise the one or more interfaces rendered as a web user interface, an application user interface, a user device, a backend system, or the like. In some embodiments, the input/output circuitry 206 also includes a keyboard, a mouse, a joystick, a touch screen, touch areas, soft keys, a microphone, a speaker, or other input/output mechanisms. The processor 202, and/or input/output circuitry 206 comprising a processor, in some embodiments is configured to control one or more functions of one or more user interface elements through computer program instructions (e.g., software and/or firmware) stored on a memory accessible to the processor 202 (e.g., memory 204, and/or the like). In some embodiments, the input/output circuitry 206 includes or utilizes a user-facing application to provide input/output functionality to a service maintainer device and/or other display associated with a user.

The communications circuitry 208 includes any means such as a device or circuitry embodied in either hardware or a combination of hardware and software that is configured to receive and/or transmit data from/to a communications network and/or any other computing device, circuitry, or module in communication with the computing device 200. In this regard, the communications circuitry 208 includes, for example in some embodiments, a network interface for enabling communications with a wired or wireless communications network. Additionally, or alternatively in some embodiments, the communications circuitry 208 includes one or more network interface cards, one or more antennas, one or more busses, one or more switches, one or more routers, one or more modems, and supporting hardware, firmware, and/or software, or any other device suitable for enabling communications via one or more communication networks. Additionally, or alternatively, the communications circuitry 208 includes circuitry for interacting with the one or more antennas and/or other hardware or software to cause transmission of signals via the one or more antennas or to handle receipt of signals received via the one or more antennas. In some embodiments, the communications circuitry 208 enables transmission to and/or receipt of data from one or more computing devices 200 and/or systems of one or more computing devices 200.

The one or more sensors 210 include hardware, software, firmware, and/or a combination thereof, that supports generation, capturing, aggregating, retrieval, and/or receiving of one or more portions of data, such as sensor data and/or image data. The one or more sensors 210 in some embodiments are affixed to, within, and/or otherwise a part of a shuttle including or otherwise associated with the computing device 200. For example, in some embodiments, one or more of the sensors 210 are mounted to the shuttle. Non-limiting examples of sensors 210 include position sensors, pressure sensors (e.g., weight sensors), speed sensors, accelerometers, image cameras, video cameras, infrared sensors, and/or the like. In some embodiments, the one or more sensors 210 include any of a myriad of sensors conventionally associated with fulfilment systems.

In some embodiments, the one or more sensors 210 include hardware, software, firmware, and/or a combination thereof, embodying one or more navigation or positional sensors. In some embodiments, the one or more navigation or positional sensors include a global positioning satellite (GPS) tracking chip and/or the like enabling location services to be requested and/or determined for a particular shuttle. Additionally, or alternatively, in some embodiments, the one or more sensors 210 include hardware, software, firmware, and/or any combination thereof, embodying one or more inertial navigation sensors that measure speed, acceleration, orientation, and/or position-related data in a 3D environment. Additionally, or alternatively, in some embodiments, the one or more sensors 210 include one or more cameras associated with a synthetic vision system (SVS). In some such embodiments, such an SVS camera captures image data representations of the real-world environment around a shuttle for use in generating one or more corresponding user interface depicting the captured image data, augmenting such image data, and/or otherwise providing data to enable an operator to acquire situational awareness based at least in part on the captured image data. It will be appreciated that, in some embodiments, the one or more sensors 210 include a separate processor, specially configured field programmable gate array (FPGA), or a specially programmed application specific integrated circuit (ASIC).

It will be appreciated that, in some embodiments, two or more of the sets of circuitries 202-210 are combinable. Additionally, or alternatively, in some embodiments, one or more of the sets of circuitry 202-216 perform some or all of the functionality described associated with another component. For example, in some embodiments, one or more of the sets of circuitry 202-210 are combined into a single component embodied in hardware, software, firmware, and/or a combination thereof. Similarly, in some embodiments, one or more of the sets of circuitry is/are combined with the processor 202, such that the processor 202 performs one or more of the operations described above with respect to each of these other sets of circuitry.

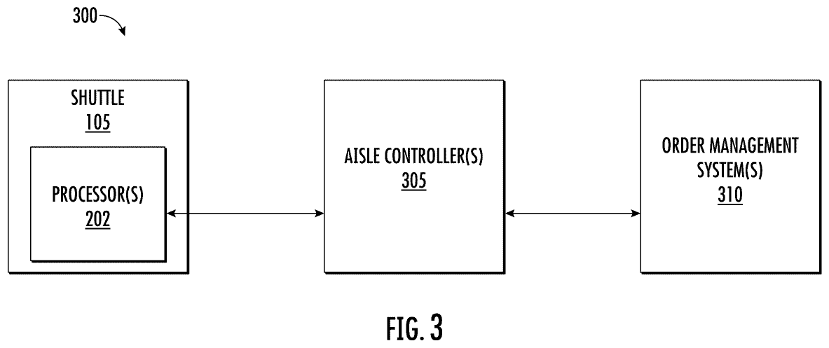

FIG. 3 is a system diagram 300 showing example devices and components for determining shuttle loading positions for a multi-load shuttle in accordance with one or more embodiments of the present disclosure. As shown in the system diagram 300, an example system of the present disclosure may include one or more shuttles 105, one or more aisle controllers 305, one or more order management systems 310, one or more processors 202, or any combination thereof. In some examples, the shuttle 105 may include the one or more processors 202 (e.g., as a subcomponent of a computing device 200 of the shuttle 105), however, other examples may include one or more processors 202 that are not subcomponents of the shuttle 105.

In some examples, a shuttle 105 may be a device or component that transports one or more loads (e.g., items, objects, payloads, products) to one or more locations within a system, such as an order fulfilment system. A shuttle 105 may be propelled by one or more motion systems, such as one or more motors, one or more drive systems (e.g., belt drive systems), and/or the like. As described herein, a shuttle 105 may be an example of a subcomponent of an ASRS. In some examples, a shuttle may be equipped with one or more control systems, such as one or more computing devices 200 (e.g., including one or more processors 202), which may be configured to control the movement and/or operations of the shuttle 105 by communicating one or more control signals to the one or more motion systems and/or load selection systems (e.g., arms and/or fingers for retrieving loads) of the shuttle 105 and/or one or more systems configured to steer, orient, or otherwise position the shuttle 105.

In some examples, a shuttle 105 may communicate with one or more other devices or components of an order fulfillment system (e.g., one or more aisle controllers 305, one or more order management systems 310) via a wireless and/or wired network. For example, a computing device 200 of a shuttle 105 may include communication circuitry, which may enable the shuttle 105 to wirelessly communicate with one or more other devices. In some examples, a shuttle 105 may be in communication with one or more external computing devices, such as an aisle controller 305 and/or a computing device 200 that hosts an order management system 310. In such examples, the shuttle 105 may receive one or more messages from the one or more external computing devices. For example, the shuttle 105 may receive one or more messages including one or more indications from an aisle controller 305. In some examples, the one or more messages may include one or more orders. In such examples, an order may indicate load retrieval information, such as any combination of one or more loads for retrieval by the shuttle 105, one or more retrieval locations for the one or more loads (e.g., one or more pickup locations), one or more load delivery sequences, one or more drop locations for the one or more loads, one or more measurements for the one or more loads (e.g., load lengths, load widths, load heights, load volumes, load weights), one or more load identifiers for the one or more loads (e.g., load barcodes, alphabetic and/or numeric identifiers), one or more side identifiers for the one or more loads (e.g., indicative of which side of a storage system the one or more loads are stored on), and/or the like.

In some examples, the shuttle 105 may receive the load retrieval information and determine one or more loading positions for the one or more loads based on the load retrieval information. For example, the shuttle 105 may determine to place a first load retrieved from a first side of the shuttle 105 at an interior loading position (e.g., a first loading position) based on load retrieval information that indicates a second load is to be retrieved from the first side (e.g., subsequent to the retrieval of the first load). Accordingly, placing the first load at the interior loading position may enable the second load to be placed at the exterior position without repositioning (e.g., reshuffling) the first load, which may conserve power and improve cycle time.

As described herein, a shuttle 105 may be an example of a multi-load shuttle, which may be capable of transporting a plurality of loads simultaneously. In such examples, a shuttle 105 may receive an order requesting the retrieval of multiple loads, the shuttle 105 may depart from a starting location (e.g., a home location, a drop location), the shuttle 105 may retrieve the multiple loads without iteratively returning to the drop location between loads, and the shuttle 105 may deliver the multiple loads to the drop location together (e.g., at one time). By transporting the multiple loads simultaneously, power consumption and cycle time may be reduced.

In some examples, an algorithm (e.g., a preplanning algorithm) may be executed (e.g., by the one or more processors 202) to determine loading positions for loads retrieved by a shuttle 105. As described herein, the algorithm may enable the optimization of load retrieval and placement operations such that reshuffling of loads (e.g., on the shuttle 105, after the shuttle 105 is unloaded) is minimized for a given order. For example, the one or more processors 202 (e.g., of the shuttle 105) may determine that one or more loads are to be retrieved or otherwise loaded onto the shuttle 105 from the same side. Accordingly, the one or more processors 202 may determine that the first load should be placed at an interior loading position, which may enable the shuttle 105 to efficiently load a second load to an exterior loading position (e.g., without having to move the first load from the exterior loading position to the interior loading position).

In some examples, the one or more processors 202 may additionally, or alternatively determine (e.g., using the algorithm) one or more loading positions for one or more loads retrieved by the shuttle 105 based on a drop sequence for the one or more loads. For example, the one or more processors 202 may initially determine a shuttle loading sequence for loading the shuttle 105 such that loads are positioned on the shuttle 105 in accordance with the drop sequence. Such operations may enable the shuttle 105 to drop the one or more loads sequentially in the drop sequence without reshuffling the loads. Once the one or more processors 202 have determined the loading sequence based on the drop sequence, the one or more processors 202 may then cause the shuttle 105 to place the one or more loads in the one or more loading positions that are determined based on the drop sequence and/or the one or more load retrieval locations for the one or more loads.

Some examples described herein refer to one or more processors 202 of the shuttle 105 performing operations, making determinations, and/or executing algorithms. However, any other one or more processors 202 may perform any one or more of the operations described herein. For example, one or more processors 202 of an aisle controller 305 may execute the preplanning algorithm as described herein and communicate one or more control signals to the shuttle 105 to cause the shuttle 105 to perform one or more operations. As another illustrative example, the aisle controller 305 (e.g., one or more processors 202 of the aisle controller 305) may make one or more first determinations and one or more processors 202 of the shuttle may make one or more second determinations. For example, the aisle controller 305 may determine a loading sequence based on a drop sequence and communicate the loading sequence to the shuttle 105. The shuttle 105 may then determine one or more loading positions for the one or more loads based on the drop sequence received from the aisle controller 305.

In some examples, an aisle controller 305 may be an example of a specific type of computing device or control device that is configurable to perform any one or more of the operations described herein. For example, an aisle controller 305 may be in communication with a computing device 200 of a shuttle and/or an order management system 310, which may itself include one or more computing devices 200. The aisle controller 305 may receive information from the order management system 310, such as one or more orders, and communicate the information to the computing device 200 of the shuttle 105.

In some examples, an order management system 310 may be an example of a system for organizing, managing, communicating, and/or tracking information associated with one or more loads in an order fulfilment system. In some examples, an order management system 310 may include software, hardware, or any combination thereof that enables information to be organized, managed, communicated, and/or tracked. For example, an order management system 310 may include one or more computing devices 200 that communicate one or more orders to one or more aisle controllers 305. An order management system 310 may perform any one or more of the operations described herein. In some examples, an order management system may be an example of a WES.

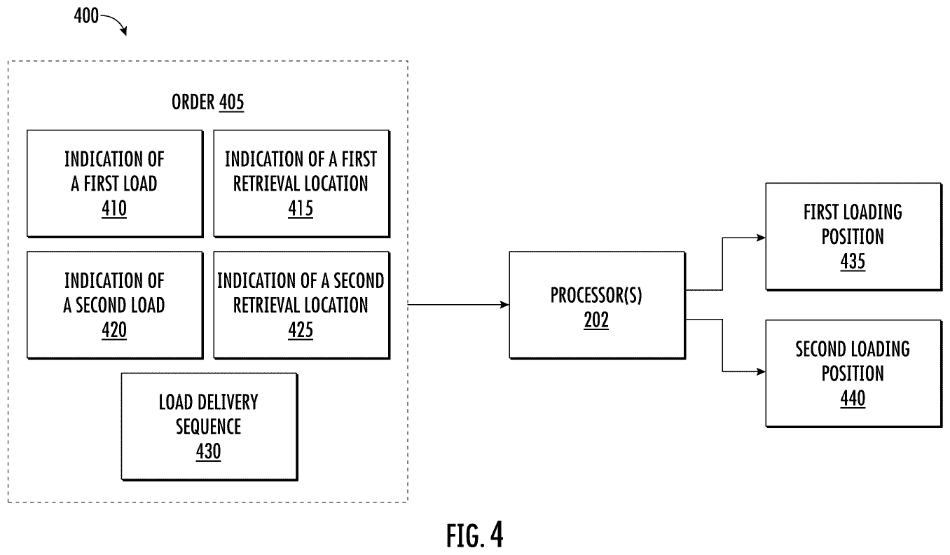

FIG. 4 is a dataflow diagram 400 showing example data structures and modules for determining shuttle loading positions for a multi-load shuttle in accordance with one or more embodiments of the present disclosure. In some examples, one or more processors 202 may receive an indication of a first load 410 for retrieval by a shuttle 105 that is configurable to simultaneously transport a plurality of loads and an indication of a first retrieval location 415 for the first load. In some examples, a shuttle 105 may be a device or component that transports one or more loads (e.g., items, objects, payloads, products) to one or more locations within a system, such as an order fulfilment system. A shuttle 105 may be propelled by one or more motion systems, such as one or more motors, one or more drive systems (e.g., belt drive systems), and/or the like. As described herein, a shuttle 105 may be an example of a subcomponent of an automated storage and retrieval system (ASRS). In some examples, a shuttle 105 may be equipped with one or more control systems, such as one or more computing devices (e.g., including one or more processors 202), which may be configured to control the movement and/or operations of the shuttle 105 by communicating one or more control signals to the one or more motion systems and/or load selection systems (e.g., arms and/or fingers for retrieving loads) of the shuttle 105 and/or one or more systems configured to steer, orient, or otherwise position the shuttle 105.

In some examples, a shuttle 105 may communicate with one or more other devices or components of an order fulfillment system via a wireless and/or wired network. For example, a computing device of a shuttle 105 may include communication circuitry, which may enable the shuttle 105 to wirelessly communicate with one or more other devices. In some examples, a shuttle 105 may be in communication with one or more external computing devices, such as an aisle controller and/or a computing device that hosts an order management system. In such examples, the shuttle 105 may receive one or more messages from the one or more external computing devices. For example, the shuttle 105 may receive one or more messages including one or more indications from an aisle controller. In some examples, the one or more messages may include one or more orders 405. In such examples, an order 405 may indicate load retrieval information, such as any combination of one or more loads for retrieval by the shuttle 105, one or more retrieval locations for the one or more loads (e.g., one or more pickup locations), one or more load delivery sequences 430, one or more drop locations for the one or more loads, one or more measurements for the one or more loads (e.g., load lengths, load widths, load heights, load volumes, load weights), one or more load identifiers for the one or more loads (e.g., load barcodes, alphabetic and/or numeric identifiers), one or more side identifiers for the one or more loads (e.g., indicative of which side of the shuttle 105 the one or more loads are stored on), and/or the like.

In some examples, the shuttle 105 may receive the load retrieval information and determine one or more loading positions for the one or more loads based on the load retrieval information. For example, the shuttle 105 may determine to place a first load retrieved from a first side of the shuttle 105 at an interior loading position (e.g., a first loading position 435) based on load retrieval information that indicates a second load is to be retrieved from the first side (e.g., subsequent to the retrieval of the first load). Accordingly, placing the first load at the interior loading position may enable the second load to be placed at the exterior position without repositioning (e.g., reshuffling) the first load, which may conserve power and improve cycle time.

As described herein, a shuttle 105 may be an example of a multi-load shuttle 105, which may be capable of transporting a plurality of loads simultaneously. In such examples, a shuttle 105 may receive an order 405 requesting the retrieval of multiple loads, the shuttle 105 may depart from a starting location (e.g., a home location, a drop location), the shuttle 105 may retrieve the multiple loads without iteratively returning to the drop location between loads, and the shuttle 105 may deliver the multiple loads to the drop location together (e.g., at one time). By transporting the multiple loads simultaneously, power consumption and cycle time may be reduced.

In some examples, an algorithm (e.g., a preplanning algorithm) may be executed (e.g., by one or more computing devices, by one or more computing devices of a shuttle 105) to determine loading positions for loads retrieved by a shuttle 105. As described herein, the algorithm may enable the optimization of load retrieval and placement operations such that reshuffling of loads (e.g., on the shuttle 105, after the shuttle 105 is unloaded) is minimized for a given order 405. For example, a computing device (e.g., of the shuttle 105) may determine that one or more loads are to be retrieved or otherwise loaded onto the shuttle 105 from the same side. Accordingly, the computing device may determine that the first load should be placed at an interior loading position, which may enable the shuttle 105 to efficiently load a second load to an exterior loading position (e.g., without having to move the first load from the exterior loading position to the interior loading position).

In some examples, a computing device (e.g., of the shuttle 105) may additionally, or alternatively determine (e.g., using the algorithm) one or more loading positions for one or more loads retrieved by the shuttle 105 based on a drop sequence for the one or more loads. For example, the computing device may initially determine a shuttle 105 loading sequence for loading the shuttle 105 such that loads are positioned on the shuttle 105 in accordance with the drop sequence. Such operations may enable the shuttle 105 to drop the one or more loads sequentially in the drop sequence without reshuffling the loads. Once the shuttle 105 has determined the loading sequence based on the drop sequence, the shuttle 105 may then place the one or more loads in the one or more loading positions that are determined based on the drop sequence and/or the one or more load retrieval locations for the one or more loads.

Some examples described herein refer to a computing devices of the shuttle 105 performing operations, making determinations, and/or executing algorithms. However, any other computing device may perform any one or more of the operations described herein. For example, an aisle controller may execute the preplanning algorithm as described herein and communicate one or more control signals to the shuttle 105 to cause the shuttle 105 to perform one or more operations. As another illustrative example, the aisle controller may make one or more first determinations and a computing device of the shuttle 105 may make one or more second determinations. For example, the aisle controller may determine a loading sequence based on a drop sequence and communication the loading sequence to the shuttle 105. The shuttle 105 may then determine one or more loading positions for the one or more loads based on the drop sequence received from the aisle controller.

In some examples, a retrieval location may be a location or position of a load within a storage area or device. For example, a retrieval location may be a location of a container within a container storage shelving unit. In some examples, an order 405 may include one or more indications of one or more retrieval locations for one or more loads. As described herein, one or more computing devices may determine one or more loading positions based on one or more retrieval locations for one or more loads. For example, a computing device may determine to place a first load in a first loading position 435 (e.g., an interior loading position) if the first load and a second load are located on a same side of a shuttle 105.

In some examples, a load may be an object or item that is conveyed by a shuttle 105 in an order fulfilment system. A load may include a container or pallet, either of which may include one or more items. As described herein, a load may be stored at one or more storage locations (e.g., retrieval locations). A shuttle 105 may then remove a load from a retrieval location and place the load at one or more loading positions of the shuttle 105. The shuttle 105 may then convey the load to a delivery location (e.g., a drop location). In some examples, a load may be identified using one or more load identifiers, such as a barcode, an alphabetic code, and/or a numeric code.

In some examples, an order 405 may be a message or communication that indicates one or more loads to be retrieved by a shuttle 105. For example, an order 405 may be indicative of a request for a shuttle 105 to retrieve one or more loads from one or more retrieval locations. In some examples, an order 405 may be a message that includes various types of information. For example, an order 405 may include one or more indications of one or more retrieval locations (e.g., pick locations), one or more indications of one or more drop locations, one or more indications of one or more load dimensions (e.g., load lengths), one or more indications of one or more load identifiers, and/or one or more indications of one or more load sides (e.g., indications of which side of a shuttle 105 a load is stored on).

In some examples, the one or more processors 202 may receive an indication of a second load 420 for retrieval by the shuttle 105 and an indication of a first retrieval location 425 for the second load. In some examples, the one or more processors 202 may determine a first loading position 435 on the shuttle 105 for placing the first load based on the first retrieval location and the second retrieval location.

In some examples, a loading position may be a position or location on a shuttle 105. For example, a shuttle 105 may include a flat surface or platform where one or more containers or pallets may be placed. As described herein, the locations of the containers or pallets on the shuttle 105 may be referred to as loading positions. In some examples, a shuttle 105 may have multiple loading positions, which may be preconfigured or otherwise fixed. In some other examples, one or more loading positions of a shuttle 105 may be configurable or otherwise dynamically determined based on one or more factors, parameters, and/or conditions. For example, a computing device of a shuttle 105 may determine one or more loading positions based on one or more size parameters for one or more loads, such as load length.

In some examples, one or more computing devices may determine one or more loading positions based on one or more load retrieval locations for one or more loads and/or based on the retrieval sequence for the one or more loads. For example, the one or more computing devices may determine that two loads for retrieval (e.g., as part of a single order 405) are stored on a same side of a shuttle 105 (e.g., in one or more shelving units located on a left side of the shuttle 105). A first load of the two loads may be queued for retrieval prior to retrieval of a second load of the two loads. Accordingly, the one or more computing devices may determine a first loading position 435 for a first load of the two loads and a second loading position 440 for a second load of the two loads. The first loading position 435 may be an interior loading position and the second loading position 440 may be an exterior loading position. The determined loading positions may enable the second load to be loaded onto the shuttle 105 without reshuffling or otherwise moving the first load. In some examples, the one or more processors 202 may cause the shuttle 105 to place the first load in the first loading position 435 based on determining the first loading position 435.

In some examples, the one or more processors 202 may determine that the first retrieval location and the second retrieval location are on a same side of the shuttle 105, wherein the first loading position 435 is based on the determining that the first retrieval location and the second retrieval location are on a same side of the shuttle 105. In some examples, a side may be a position or location relative to a central point or a component of an order fulfilment system. For example, ASRS may include a shuttle 105 that travels in two directions along a track. The track may be flanked by shelving units on either side of the shuttle 105. For example, a first shelving unit may be located on a left side of the shuttle 105 (e.g., side 1) and a second shelving unit may be located on a right side of the shuttle 105 (e.g., side 2).

In some examples, the one or more processors 202 may cause the shuttle 105 to place the second load in a second loading position 440 without repositioning the first load. In some examples, repositioning may include moving, shuffling, or otherwise reorganizing one or more loads on a shuttle 105 or in any other region of an order fulfilment system. For example, a shuttle 105 may perform one or more operations to move a first load from a first loading position 435 to a second loading position 440. As another illustrative example, a shuttle 105 may drop a plurality of loads at a drop location. The plurality of loads may be transported to a sorting area and one or more individuals may reposition the plurality of loads. As described herein, some conventional load retrieval techniques may include repositioning a load from a first loading position 435 to a second loading position 440 (e.g., to make room for a second load to be loaded onto a shuttle 105). For example, a conventional load retrieval technique may include placing a first load in a second loading position 440 of a shuttle 105 (e.g., an exterior loading position) and then repositioning or otherwise moving the first load from the second loading position 440 to a first loading position 435 (e.g., an interior loading position) to make room for a second load to be loaded into the second loading position 440. However, such repositioning operations may be slower and may consume more energy resources than the techniques of the present disclosure.

In some examples, the second loading position 440 is closer to an outer edge of the shuttle 105 than the first loading position 435. In some examples, an outer edge may be a geometrical region of a shuttle 105. For example, an outer edge of a shuttle 105 may be an edge or extent of a shuttle 105 that is parallel to the direction of travel of the shuttle 105. In some examples, a load that is placed onto the shuttle 105 may cross over a plane that is parallel with the outer edge of the shuttle 105. In some examples, a shuttle 105 may have multiple outer edges. For example, a first outer edge of the shuttle 105 may be located on a first side of the shuttle 105 (e.g., side 1, the left side of the shuttle 105) and a second outer edge of the shuttle 105 may be located on a second side of the shuttle 105 (e.g., side 2, the right side of the shuttle 105).

In some examples, a loading position may be described with reference to one or more outer edges of a shuttle 105. For example, a first loading position 435 (e.g., a first interior loading position) may be further from a first outer edge (e.g., a left outer edge) of a shuttle 105 than a second loading position 440 (e.g., a first exterior loading position). Additionally, or alternatively, a third loading position (e.g., a second interior loading position) may be further from a second outer edge (e.g., a right outer edge) of a shuttle 105 than a further loading position (e.g., a second exterior loading position).

In some examples, the first loading position 435 is based on a load delivery sequence 430. In some examples, a load delivery sequence 430 may be a sequence or ordering for unloading, outputting, or delivery two or more loads. For example, a shuttle 105 may deliver two or more loads to one or more subsystems or subcomponents of an order fulfilment system in a specific load delivery sequence 430. In some examples, a load delivery sequence 430 may be specified or otherwise indicated by an order 405. In some examples, one or more computing devices may determine one or more loading positions for one or more loads based on a load delivery sequence 430. In some examples, the one or more processors 202 may receive an indication of the load delivery sequence 430. In some examples, the shuttle 105 may include the one or more processors 202.

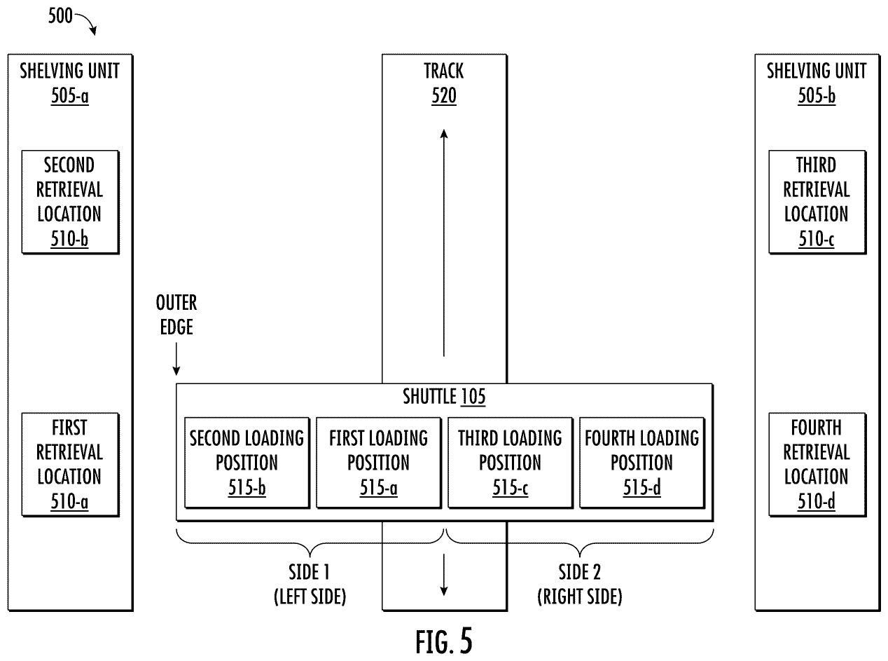

FIG. 5 is an operational example 500 of a system architecture that supports determining shuttle loading positions for a multi-load shuttle in accordance with one or more embodiments of the present disclosure. The operational example 500 may include a shuttle 105, a track 520, a shelving unit 505-a, and/or a shelving unit 505-b. As shown, the shuttle 105 may travel along the track 520 in one or more directions (e.g., one or more directions parallel to the track 520). The shuttle 105 may utilize one or more components (e.g., one or more load retrieval components, one or more fingers) to retrieve one or more loads from one or more load retrieval locations 510. As described herein, the shuttle 105 may determine one or more loading positions 515 for one or more loads based on whether two or more loads are to be placed onto the shuttle 105 from a same side.

As shown, the shuttle may have two sides (e.g., two halves, side 1, side 2). The first side of the shuttle 105 may be adjacent to shelving unit 505-a and the second side of the shuttle 105 may be adjacent to shelving unit 505-b. As described herein, the shuttle 105 may receive one or more indications to retrieve a first load from the first retrieval location 510-a, a second load from the second retrieval location 510-b, a third load from the third retrieval location 510-c, and a fourth load from the fourth retrieval location 510-d. In response to receiving the one or more indications, the shuttle 105 may determine one or more loading positions 515 for the first load, the second load, the third load, and the fourth load. In some examples, the shuttle 105 may determine the one or more loading positions 515 based on which side of the shuttle 105 the one or more loads are located on and/or how many loads are to be retrieved from a same side. For example, the shuttle 105 may determine to place the first load in the first loading position 515-a and the second load in the second loading position 515-b (e.g., because the first load and the second load are stored in the shelving unit 505-a and are to be loaded onto the shuttle 105 from a same side). Additionally, or alternatively, the shuttle 105 may determine to place the third load in the third loading position 515-c and the fourth load in the fourth loading position 515-d.

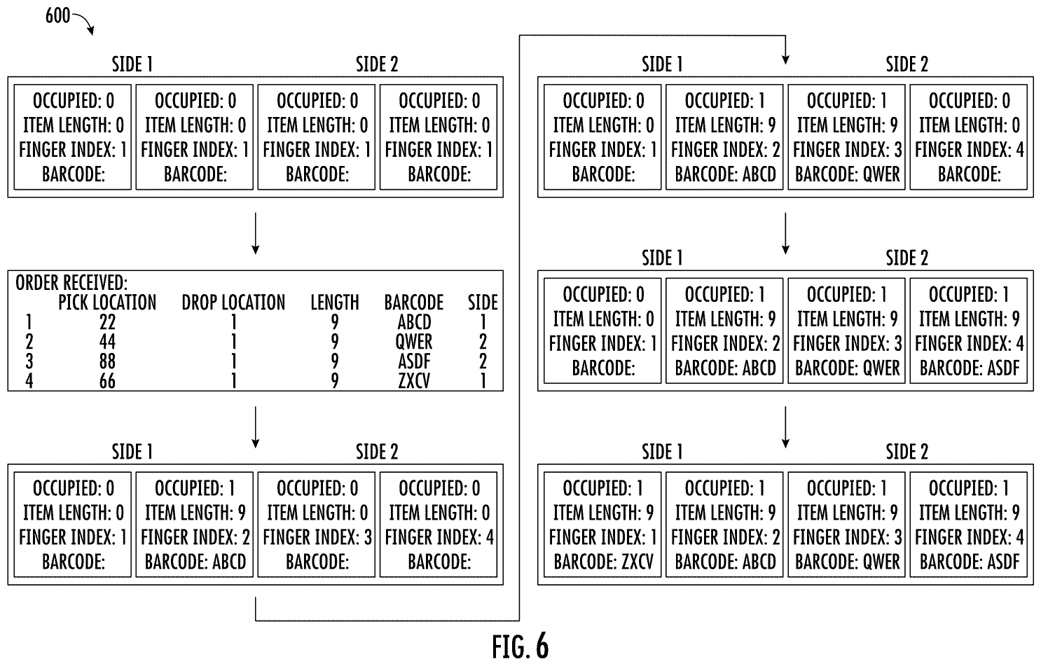

FIG. 6 is an operational example 600 of shuttle loading configurations that support determining shuttle loading positions for a multi-load shuttle in accordance with one or more embodiments of the present disclosure. As shown, the operational example 600 may provide examples of loading configurations and corresponding loading information for a shuttle 105 at various time instances prior to and/or during a load retrieval operation. Additionally, the operational example 600 may depict an example of an order that is received by a shuttle 105 and/or causes the shuttle 105 to retrieve one or more loads. For example, a shuttle 105 may be unloaded at a first time instance and an order may be received at a second time instance. The order may include indications to retrieve four loads having barcodes ABCD, QWER, ASDF, and ZXCV. At a third time instance, the shuttle 105 may place load ABCD in a first loading position (e.g., finger index 2), at a fourth time instance the shuttle 105 may place load QWER in a third loading position (e.g., finger index 3), at a fifth time instance the shuttle 105 may place load ASDF in a fourth loading position (e.g., finger index 4), and at a fifth time instance the shuttle 105 may place load ZXCV in a second loading position (e.g., finger index 1).

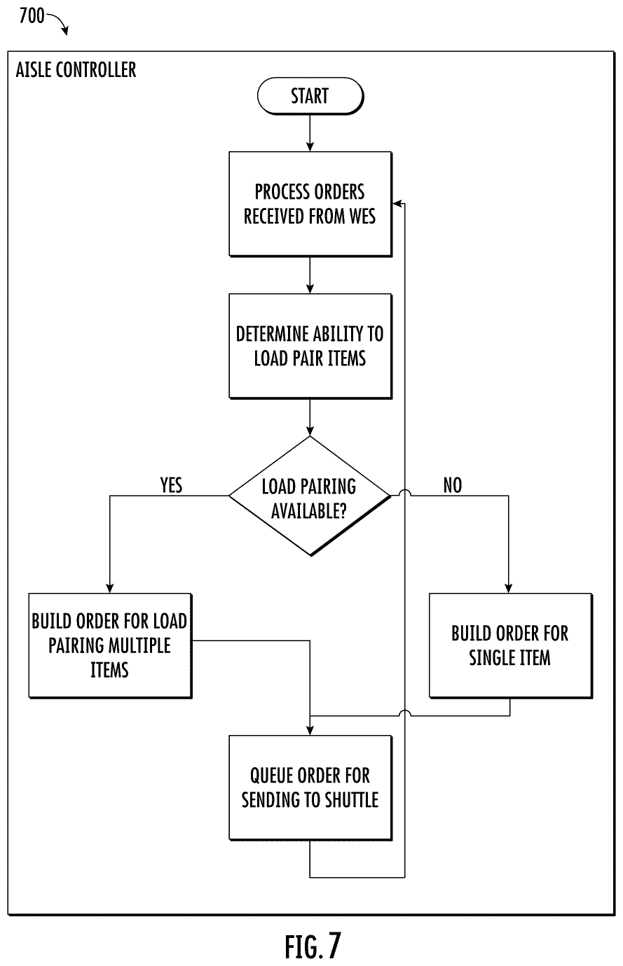

FIG. 7 is an operational example 700 of a process that supports determining shuttle loading positions for a multi-load shuttle in accordance with one or more embodiments of the present disclosure. Specifically, FIG. 7 depicts operations of the process. In some embodiments, the process is embodied by computer program code stored on a non-transitory computer-readable storage medium of a computer program product configured for execution to perform the process as depicted and described. Additionally, or alternatively, in some embodiments, the process is performed by at least one specially configured computing device, such as at least one computing device 200 alone or in communication with at least one other component, device, system, and/or the like. In this regard, in some such embodiments, the computing device 200 is specially configured by computer-coded instructions (e.g., computer program instructions) stored thereon, for example in the memory 204 and/or another component depicted and/or described herein and/or otherwise accessible to the computing device 200, for performing the operations as depicted and described. In some embodiments, the computing device 200 is in communication with at least one external apparatus, system, device, and/or the like, to perform at least one of the operations as depicted and described. For example, the computing device 200 (e.g., a computing device 200 of an aisle controller), in some embodiments, is in communication with an external computing device (e.g., a computing device 200 of a shuttle), a client device, and/or the like. For purposes of simplifying the description, the process is described as performed by and from the perspective of the computing device 200.

As shown, the computing device 200 may receive and/or process one or more orders indicating one or more loads for retrieval. In some examples, the one or more orders may be received from one or more computing devices 200 of an order management system. In response to receiving the one or more orders, the computing device 200 may determine if the one or more loads may be paired (e.g., may be loaded onto the shuttle simultaneously). If the one or more loads may be loaded onto the shuttle simultaneously, the computing device 200 may generate a multi-load order and send the multi-load order to the shuttle. If the one or more loads may not be loaded onto the shuttle (e.g., if the one or more loads are too large for simultaneously loading onto the shuttle), the computing device 200 may generate one or more single load orders and send the one or more single load orders to the shuttle.

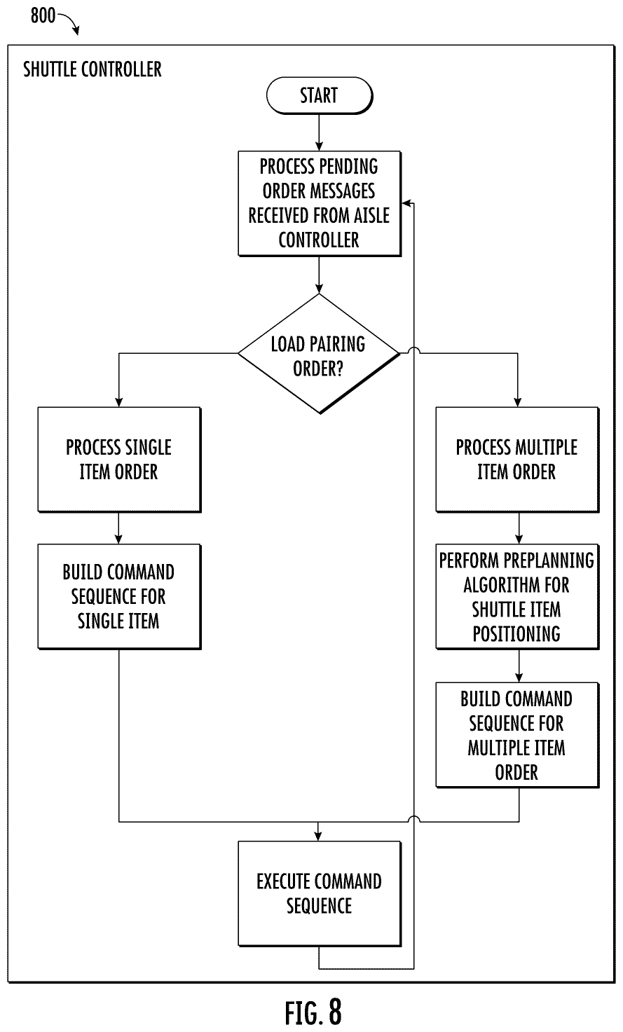

FIG. 8 is an operational example 800 of a process that supports determining shuttle loading positions for a multi-load shuttle in accordance with one or more embodiments of the present disclosure. Specifically, FIG. 8 depicts operations of the process. In some embodiments, the process is embodied by computer program code stored on a non-transitory computer-readable storage medium of a computer program product configured for execution to perform the process as depicted and described. Additionally, or alternatively, in some embodiments, the process is performed by at least one specially configured computing device, such as at least one computing device 200 alone or in communication with at least one other component, device, system, and/or the like. In this regard, in some such embodiments, the computing device 200 is specially configured by computer-coded instructions (e.g., computer program instructions) stored thereon, for example in the memory 204 and/or another component depicted and/or described herein and/or otherwise accessible to the computing device 200, for performing the operations as depicted and described. In some embodiments, the computing device 200 is in communication with at least one external apparatus, system, device, and/or the like, to perform at least one of the operations as depicted and described. For example, the computing device 200 (e.g., a computing device 200 of a shuttle, a shuttle controller), in some embodiments, is in communication with an external computing device (e.g., a computing device 200 of an aisle, an aisle controller), a client device, and/or the like. For purposes of simplifying the description, the process is described as performed by and from the perspective of the computing device 200.

As shown, the computing device 200 may receive and/or process one or more orders indicating one or more loads for retrieval. In some examples, the one or more orders may be received from an aisle controller. In response to receiving the one or more orders, the computing device 200 may determine if the one or more orders are load pairing orders (e.g., multiple item orders). If the one or more orders are load pairing orders, the computing device 200 may process the one or more load pairing orders. Additionally, or alternatively, the computing device 200 may execute a preplanning algorithm that outputs one or more shuttle loading positions for one or more loads included in the one or more load pairing orders. In such examples, the computing device 200 may then generate a command sequence for the one or more orders (e.g., commands that cause the shuttle and/or one or more subcomponents of the shuttle to retrieve the loads of the one or more load pairing orders). The command sequence may then be executed, which may cause the shuttle to retrieve the loads. In some examples, the one or more orders may not be load pairing orders. In such examples, the computing device 200 may process the one or more single item orders and/or generate a command sequence for the one or more single item orders without executing the preplanning algorithm.

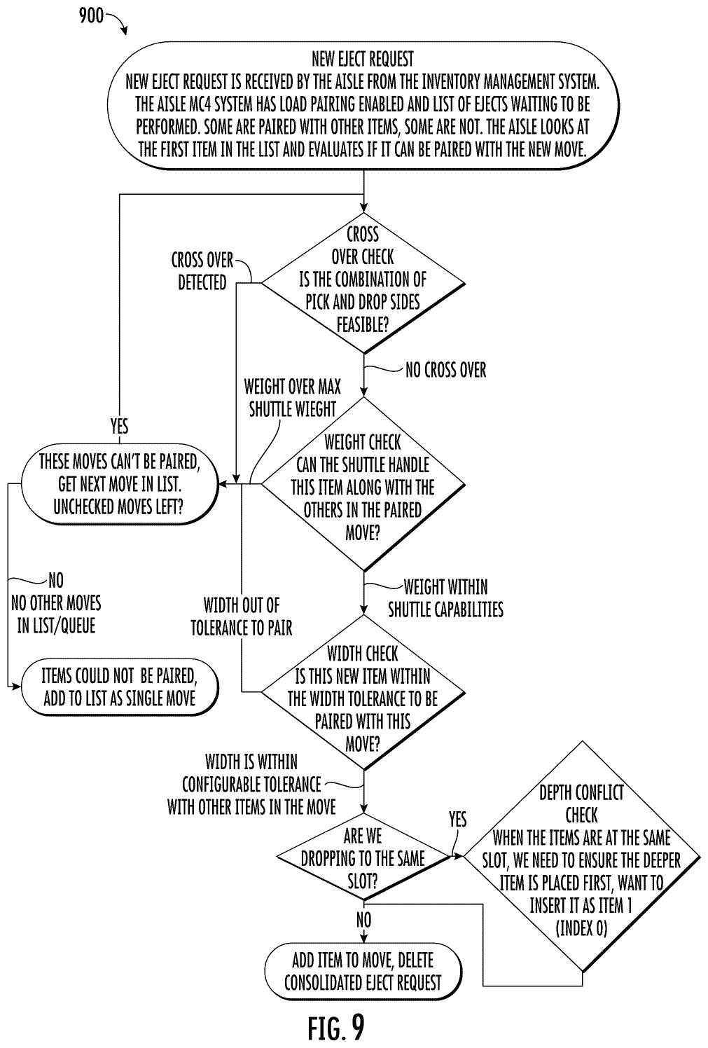

FIG. 9 is an operational example 900 of a process that supports determining shuttle loading positions for a multi-load shuttle in accordance with one or more embodiments of the present disclosure. Specifically, FIG. 9 depicts operations of the process. In some embodiments, the process is embodied by computer program code stored on a non-transitory computer-readable storage medium of a computer program product configured for execution to perform the process as depicted and described. Additionally, or alternatively, in some embodiments, the process is performed by at least one specially configured computing device, such as at least one computing device 200 alone or in communication with at least one other component, device, system, and/or the like. In this regard, in some such embodiments, the computing device 200 is specially configured by computer-coded instructions (e.g., computer program instructions) stored thereon, for example in the memory 204 and/or another component depicted and/or described herein and/or otherwise accessible to the computing device 200, for performing the operations as depicted and described. In some embodiments, the computing device 200 is in communication with at least one external apparatus, system, device, and/or the like, to perform at least one of the operations as depicted and described. For example, the computing device 200 (e.g., a computing device 200 of an aisle controller), in some embodiments, is in communication with an external computing device (e.g., a computing device 200 of a shuttle), a client device, and/or the like. For purposes of simplifying the description, the process is described as performed by and from the perspective of the computing device 200.

As shown, the computing device 200 may perform one or more operations and/or make one or more determinations in response to receiving one or more eject requests and/or one or more orders. As described herein, an eject request may be a message received by the computing device requesting one or more loads to be retrieved (e.g., ejected) from one or more storage locations. In accordance with the operational example 900, the computing device 200 may perform any one or more of a crossover check, a weight check, a width check, a depth conflict check, and/or a check to determine if one or more loads are being dropped in a same slot (e.g., at a same load output location). The computing device 200 may then determine one or more loading positions for one or more loads (e.g., indicated by the one or more eject requests) based on the one or more checks.

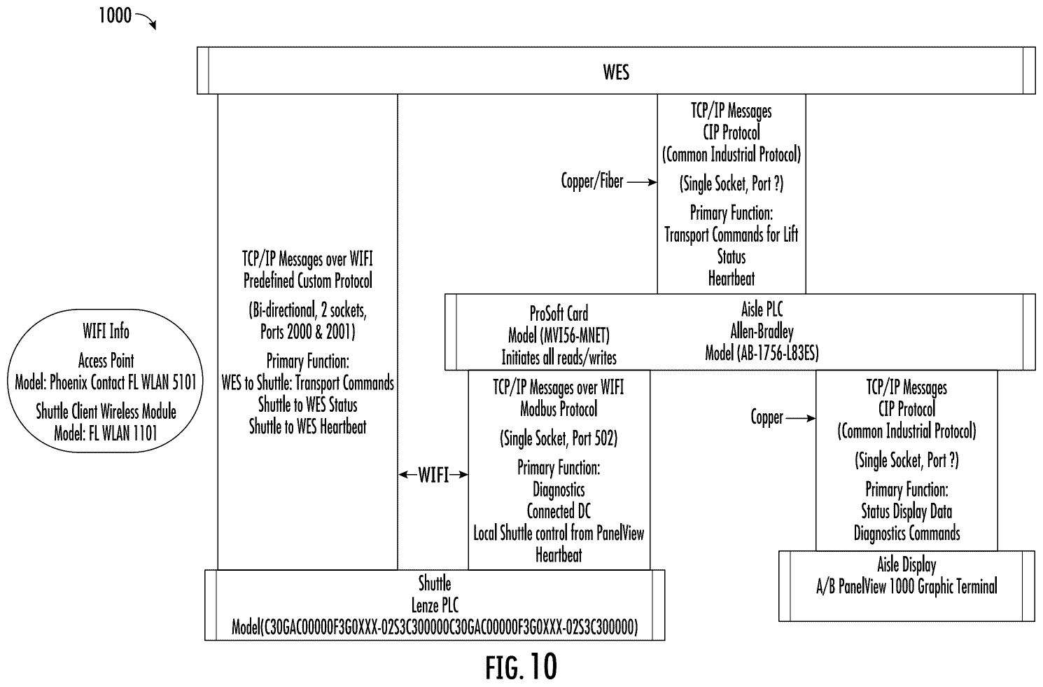

FIG. 10 is an operational example 1000 of a system architecture that supports determining shuttle loading positions for a multi-load shuttle in accordance with one or more embodiments of the present disclosure. As shown, the system architecture includes a WES, a shuttle (e.g., a shuttle including a computing device), an aisle programmable logic controller (PLC), and an aisle display, which may be in communication with one another via one or wireless and/or wired connections. In some examples, the WES may be an example of an order management system, the aisle PLC may be an example of a computing device, and the aisle display may be an example of a user interface, as described herein.

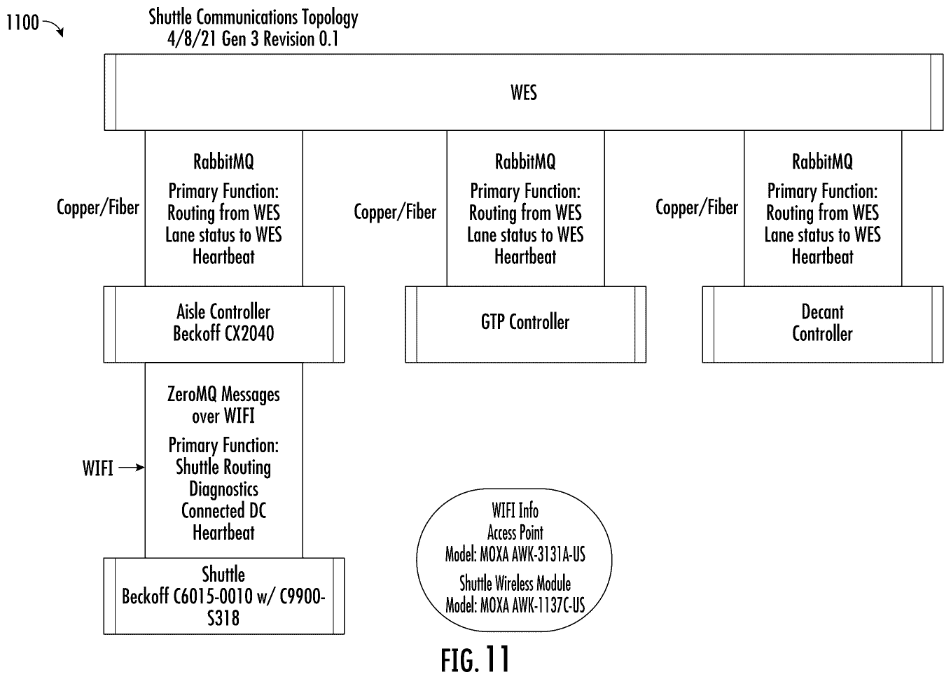

FIG. 11 is an operational example 1100 of a system architecture that supports determining shuttle loading positions for a multi-load shuttle in accordance with one or more embodiments of the present disclosure. As shown, the system architecture includes a WES, a shuttle (e.g., a shuttle including a computing device), an aisle controller, a goods-to-person (GTP) controller, and a decant controller, which may be in communication with one another via one or wireless and/or wired connections. In some examples, the WES may be an example of an order management system, the aisle controller may be an example of a computing device, the GTP controller may be an example of a computing device, and the decant controller may be an example of a computing device.

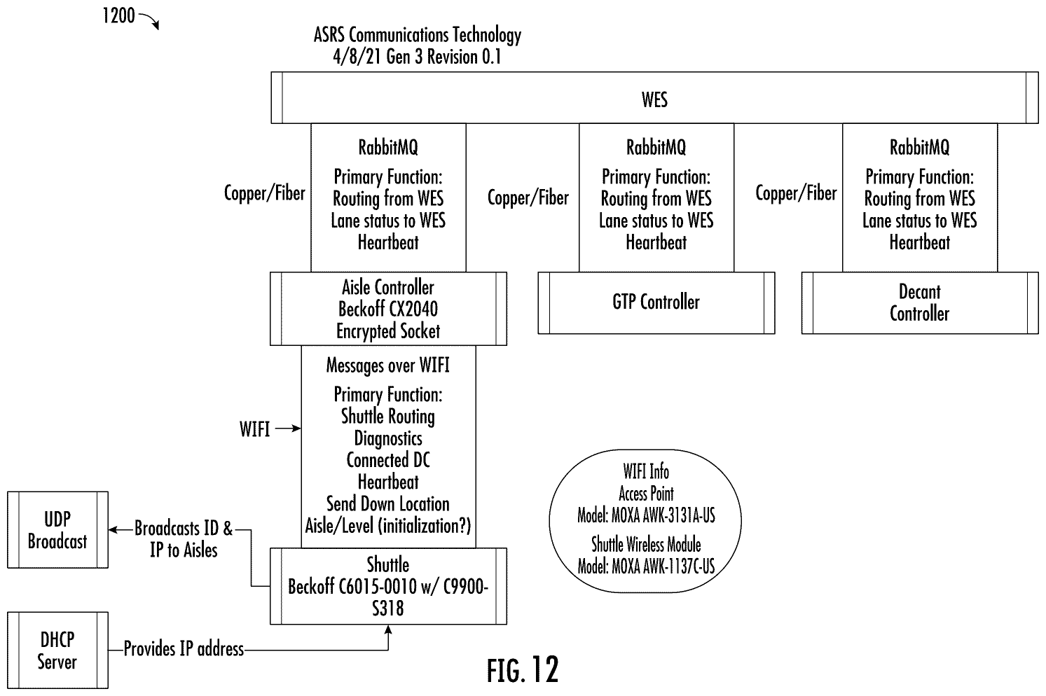

FIG. 12 is an operational example 1200 of a system architecture that supports determining shuttle loading positions for a multi-load shuttle in accordance with one or more embodiments of the present disclosure. As shown, the system architecture includes a WES, a shuttle (e.g., a shuttle including a computing device), an aisle controller, a goods-to-person (GTP) controller, and a decant controller, which may be in communication with one another via one or wireless and/or wired connections. In some examples, the WES may be an example of an order management system, the aisle controller may be an example of a computing device, the GTP controller may be an example of a computing device, and the decant controller may be an example of a computing device. In some examples, the system architecture may additionally, or alternatively include a UDP broadcast component and a DHCP server, which may each be examples of computing devices.

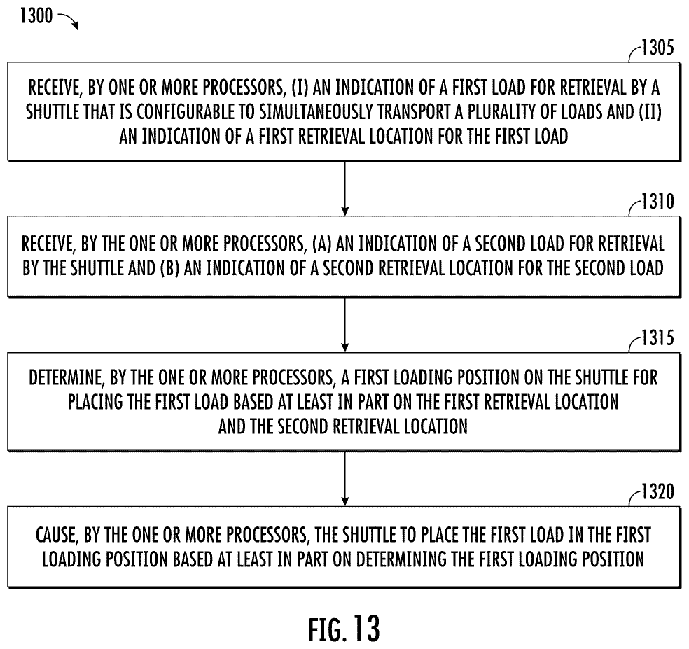

FIG. 13 is an operational example 1300 of a process that supports determining shuttle loading positions for a multi-load shuttle in accordance with one or more embodiments of the present disclosure. Specifically, FIG. 13 depicts operations of the process. In some embodiments, the process is embodied by computer program code stored on a non-transitory computer-readable storage medium of a computer program product configured for execution to perform the process as depicted and described. Additionally, or alternatively, in some embodiments, the process is performed by at least one specially configured computing device, such as at least one computing device 200 alone or in communication with at least one other component, device, system, and/or the like. In this regard, in some such embodiments, the computing device 200 is specially configured by computer-coded instructions (e.g., computer program instructions) stored thereon, for example in the memory 204 and/or another component depicted and/or described herein and/or otherwise accessible to the computing device 200, for performing the operations as depicted and described. In some embodiments, the computing device 200 is in communication with at least one external apparatus, system, device, and/or the like, to perform at least one of the operations as depicted and described. For example, the computing device 200, in some embodiments, is in communication with an external computing device, a client device, and/or the like. For purposes of simplifying the description, the process is described as performed by and from the perspective of the computing device 200.

The process begins at operation 1305. At operation 1305, the computing device 200 includes means such as the sensors 210, communications circuitry 208, input/output circuitry 206, one or more processors 202, input/output circuitry 206, or a combination thereof, to receive, by one or more processors 202, (i) an indication of a first load for retrieval by a shuttle that is configurable to simultaneously transport a plurality of loads and (ii) an indication of a first retrieval location for the first load.

At operation 1310, the computing device 200 includes means such as the sensors 210, communications circuitry 208, input/output circuitry 206, one or more processors 202, input/output circuitry 206, or a combination thereof, to receive, by the one or more processors 202, (a) an indication of a second load for retrieval by the shuttle and (b) an indication of a second retrieval location for the second load.

At operation 1315, the computing device 200 includes means such as the sensors 210, communications circuitry 208, input/output circuitry 206, one or more processors 202, input/output circuitry 206, or a combination thereof, to determine, by the one or more processors 202, a first loading position on the shuttle for placing the first load based at least in part on the first retrieval location and the second retrieval location.

At operation 1320, the computing device 200 includes means such as the sensors 210, communications circuitry 208, input/output circuitry 206, one or more processors 202, input/output circuitry 206, or a combination thereof, to cause, by the one or more processors 202, the shuttle to place the first load in the first loading position based at least in part on determining the first loading position.

### CONCLUSION

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

In some embodiments, some of the operations above may be modified or further amplified. Furthermore, in some embodiments, additional optional operations may be included. Modifications, amplifications, or additions to the operations above may be performed in any order and in any combination.

Although an example processing system has been described above, implementations of the subject matter and the functional operations described herein can be implemented in other types of digital electronic circuitry, or in computer software, firmware, or hardware, including the structures disclosed in this specification and their structural equivalents, or in various combinations.

Embodiments of the subject matter and the operations described herein can be implemented in digital electronic circuitry, or in computer software, firmware, or hardware, including the structures disclosed in this specification and their structural equivalents, or in various combinations. Embodiments of the subject matter described herein can be implemented as at least one computer program, i.e., at least one module of computer program instructions, encoded on computer storage medium for execution by, or to control the operation of, information/data processing apparatus. Alternatively, or in addition, the program instructions can be encoded on an artificially generated, propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination. Moreover, while a computer storage medium is not a propagated signal, a computer storage medium can be a source or destination of computer program instructions encoded in an artificially generated, propagated signal. The computer storage medium can also be, or be included in, at least one separate physical component or media (e.g., multiple CDs, disks, or other storage devices).

The operations described herein can be implemented as operations performed by an information/data processing apparatus on information/data stored on at least one computer-readable storage device or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or any combination thereof. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., at least one script stored in a markup language document), in a single file dedicated to the program in question, or in multiple coordinated files (e.g., files that store at least one module, sub-program,or portion of code). A computer program can be deployed to be executed on one computer or on multiple computers that are located at one site or distributed across multiple sites and interconnected by a communication network.

The processes and logic flows described herein can be performed by at least one programmable processor executing at least one computer program to perform actions by operating on input information/data and generating output. Processors suitable for the execution of a computer program include, by way of example, both general and special purpose microprocessors, and any processor of any kind of digital computer. Generally, a processor will receive instructions and information/data from a read-only memory or a random access memory or both. The essential elements of a computer are a processor for performing actions in accordance with instructions and at least one memory device for storing instructions and data. Generally, a computer will also include, or be operatively coupled to receive information/data from or transfer information/data to, or both, at least one mass storage device for storing data, e.g., magnetic, magneto-optical disks, or optical disks.

However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of at least one such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment.

Conversely, various features that are described in the context of a single embodiment can also be implemented in multiple embodiments separately or in any suitable sub combination. Moreover, although features may be described above as acting in certain combinations and even initially claimed as such, at least one feature from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, by one or more processors, (i) an indication of a first load for retrieval by a shuttle that is configurable to simultaneously transport a plurality of loads and (ii) an indication of a first retrieval location for the first load;
receiving, by the one or more processors, (a) an indication of a second load for retrieval by the shuttle and (b) an indication of a second retrieval location for the second load;
determining, by the one or more processors, a first loading position on the shuttle for placing the first load based at least in part on the first retrieval location and the second retrieval location; and
causing, by the one or more processors, the shuttle to place the first load in the first loading position based at least in part on determining the first loading position.

2. The method of claim 1, further comprising:
determining, by the one or more processors, that the first retrieval location and the second retrieval location are on a same side of the shuttle, wherein the first loading position is based at least in part on the determining that the first retrieval location and the second retrieval location are on the same side of the shuttle.

3. The method of claim 1, further comprising:
causing, by the one or more processors, the shuttle to place the second load in a second loading position without repositioning the first load.

4. The method of claim 3, wherein the second loading position is closer to an outer edge of the shuttle than the first loading position.

5. The method of claim 1, wherein the first loading position is based at least in part on a load delivery sequence.

6. The method of claim 5, further comprising:
receiving, by the one or more processors, an indication of the load delivery sequence.

7. The method of claim 1, wherein the shuttle comprises the one or more processors.

8. A system comprising:
an aisle controller; and
one or more processors in communication with the aisle controller, the one or more processors configured to:
receive, from the aisle controller, (i) an indication of a first load for retrieval by a shuttle that is configurable to simultaneously transport a plurality of loads and (ii) an indication of a first retrieval location for the first load;
receive (a) an indication of a second load for retrieval by the shuttle and (b) an indication of a second retrieval location for the second load;
determine a first loading position on the shuttle for placing the first load based at least in part on the first retrieval location and the second retrieval location; and
cause the shuttle to place the first load in the first loading position based at least in part on determining the first loading position.

9. The system of claim 8, wherein the one or more processors are further configured to:
determine that the first retrieval location and the second retrieval location are on a same side of the shuttle, wherein the first loading position is based at least in part on the determining that the first retrieval location and the second retrieval location are on the same side of the shuttle.

10. The system of claim 8, wherein the one or more processors are further configured to:
cause the shuttle to place the second load in a second loading position without repositioning the first load.

11. The system of claim 10, wherein the second loading position is closer to an outer edge of the shuttle than the first loading position.

12. The system of claim 8, wherein the first loading position is based at least in part on a load delivery sequence.

13. The system of claim 12, wherein the one or more processors are further configured to:
receive, from the aisle controller, an indication of the load delivery sequence.

14. The system of claim 8, wherein the shuttle comprises the one or more processors.

15. An apparatus comprising:
one or more processors; and
a memory storing instructions that, when executed by the one or more processors, cause the apparatus to:
receive (i) an indication of a first load for retrieval by a shuttle that is configurable to simultaneously transport a plurality of loads and (ii) an indication of a first retrieval location for the first load;
receive (a) an indication of a second load for retrieval by the shuttle and (b) an indication of a second retrieval location for the second load;
determine a first loading position on the shuttle for placing the first load based at least in part on the first retrieval location and the second retrieval location; and
cause the shuttle to place the first load in the first loading position based at least in part on determining the first loading position.

16. The apparatus of claim 15, wherein the one or more processors further cause the apparatus to:
determine that the first retrieval location and the second retrieval location are on a same side of the shuttle, wherein the first loading position is based at least in part on the determining that the first retrieval location and the second retrieval location are on the same side of the shuttle.

17. The apparatus of claim 15, wherein the one or more processors further cause the apparatus to:
cause the shuttle to place the second load in a second loading position without repositioning the first load.

18. The apparatus of claim 17, wherein the second loading position is closer to an outer edge of the shuttle than the first loading position.

19. The apparatus of claim 15, wherein the first loading position is based at least in part on a load delivery sequence.

20. The apparatus of claim 19, wherein the one or more processors further cause the apparatus to:
receive an indication of the load delivery sequence.
